(19) United States
(12) Patent Application Publication
(10) Pub. No.: US 2007/0121061 A1
(43) Pub. Date: May 31, 2007

(54) Spring hinge for eyeglasses

(75) Inventor: Young Ho Kim, Kyungsan-si (KR)

Correspondence Address: MAYER, BROWN, ROWE & MAW LLP, 1909 K STREET, N.W., WASHINGTON, DC, 20006, US

(73) Assignee: ATEC OPTICAL CO., LTD.

(21) Appl. No.: 11/543,113

(22) Filed: Oct. 5, 2006

(30) Foreign Application Priority Data
Nov. 30, 2005 (KR) 10-2005-0115975

(51) Int. Cl. G02C 5/22

(52) U.S. Cl. 351/153; 351/41

(57) ABSTRACT

Disclosed therein is a spring hinge for eyeglasses, which is rotatably connected to an eyeglasses temple or an eyeglasses rim via a hinge pin (30). The eyeglasses spring hinge includes: a first member (10) having resilient means (40) protruding toward the hinge pin (30); and a second member (20) having a cam (d) which is in resilient contact with the resilient means (40). The first member (10) includes: a pin hole (31) formed on an end portion thereof for rotatably inserting the hinge pin (30) thereto; insertion spaces of a predetermined width cut-formed at the center thereof for rotatably combining the second member (20) thereto; and an insertion hole (a) formed on a side thereof between the insertion spaces, whereby an end portion of the resilient means (40) is fittingly fixed to the insertion hole (a).

### BACKGROUND OF THE INVENTION

1. Field of the Invention

The present invention relates to a spring hinge for eyeglasses rotatably connected between an end-piece of an eyeglasses rim and an earpiece for resiliently keeping the earpiece at a specific position, and more particularly, to a spring hinge for eyeglasses, which can remarkably reduce a size thereof by simplifying its structure and enhance the degree of freedom in design of eyeglasses.

2. Background Art

In general, a spring hinge for eyeglasses includes: a slender type housing combined to an eyeglasses temple; a coil spring mounted inside the housing; a sliding member resiliently supported on the spring and performing a rectilineal motion of a predetermined width; and a feldspar member combined to an eyeglasses rim, the sliding member resiliently contacting with the feldspar member, whereby the temple can be rotated at a predetermined angle in a predetermined direction and keep a folded or spread state when it is folded or spread.

However, the prior art eyeglasses spring hinge has several problems in that it has a relatively complicated structure, provides a bad appearance due to protrusion of the housing, is deteriorated in productivity due to a long assembling process, and is restricted in design, since the eyeglasses spring hinge has the structure that the coil spring and the sliding member mounted on the spring are assembled to the housing.

### SUMMARY OF THE INVENTION

Accordingly, the present invention has been made to solve the above-mentioned disadvantages occurring in the prior art, and it is an object of the present invention to provide a spring hinge for eyeglasses, which has bar-type resilient means mounted on one of two members rotatably combined onto a hinge pin and a cam formed on the other member to be resiliently supported on the resilient means, whereby an end-piece of an eyeglasses rim and an eyeglasses temple cooperating with the two members can keep a resiliently folded or spread state.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of a spring hinge for eyeglasses according to the present invention;

FIG. 2 is an exploded perspective view of the eyeglasses spring hinge according to the present invention;

FIG. 3 is a section view of the eyeglasses spring hinge according to the present invention;

FIG. 4 is a perspective view, in partial section, of a first member according to the present invention;

FIG. 5 is a sectional view showing a spread state of a temple, which is an operation state of the present invention;

FIG. 6 is a sectional view showing an intermediate operation state of the present invention;

FIG. 7 is a sectional view showing a folded state of the temple according to the present invention;

FIG. 8 is a sectional view showing a state where the temple is bent outwardly in the spread state;

FIG. 9 is a perspective view according to a second embodiment of the present invention;

FIG. 10 is an exploded perspective view of the second embodiment of the present invention;

FIG. 11 is a sectional view of the second embodiment of the present invention;

FIG. 12 is a sectional view showing a spread state of a temple, which is an operation state of the second embodiment of the present invention;

FIG. 13 is a sectional view showing an intermediate operation state of second embodiment;

FIG. 14 is a sectional view showing a folded state of the temple according to the second embodiment;

FIG. 15 is a sectional view showing a state where the temple is bent outwardly in the spread state according to the second embodiment;

FIG. 16 is a sectional view showing a state where an insertion hole of the first member is inclined;

FIG. 17 is a sectional view of another example showing the state where the insertion hole of the first member is inclined;

FIG. 18 is a perspective view, in partial section, showing another example of the first member according to the present invention;

FIG. 19 is a perspective view showing another example of the resilient means according to the present invention;

FIG. 20 is a perspective view showing a further example of the resilient means according to the present invention;

FIG. 21 is a perspective view showing a still further example of the resilient means according to the present invention;

FIG. 22 is a sectional view showing a state where the insertion hole is punched; and

FIG. 23 is a sectional view showing another example of the first member and the second member according to the present invention.

### DETAILED DESCRIPTION OF THE PREFERRED EMBODIMENT

Reference will be now made in detail to the preferred embodiment of the present invention with reference to the attached drawings.

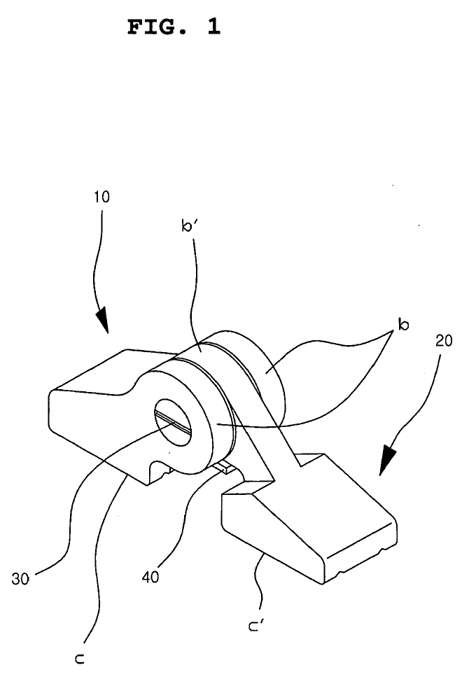

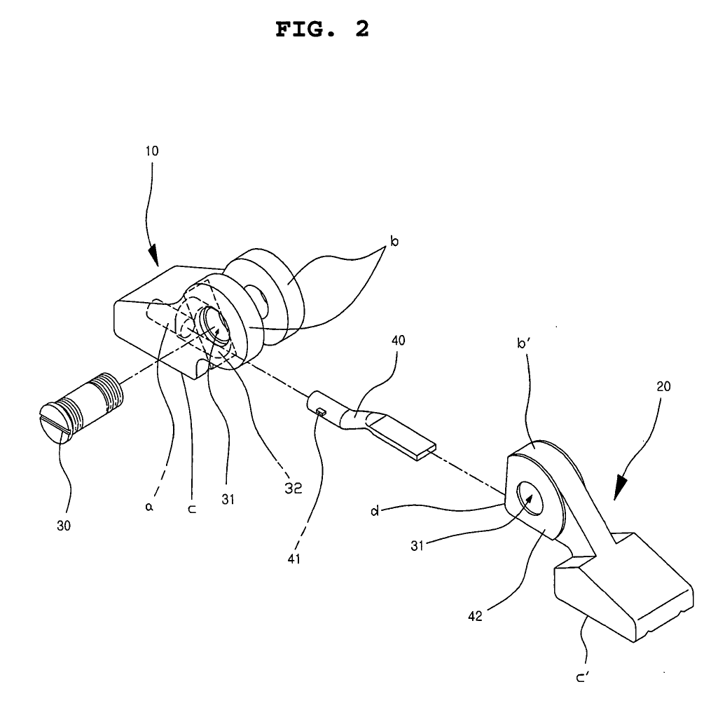

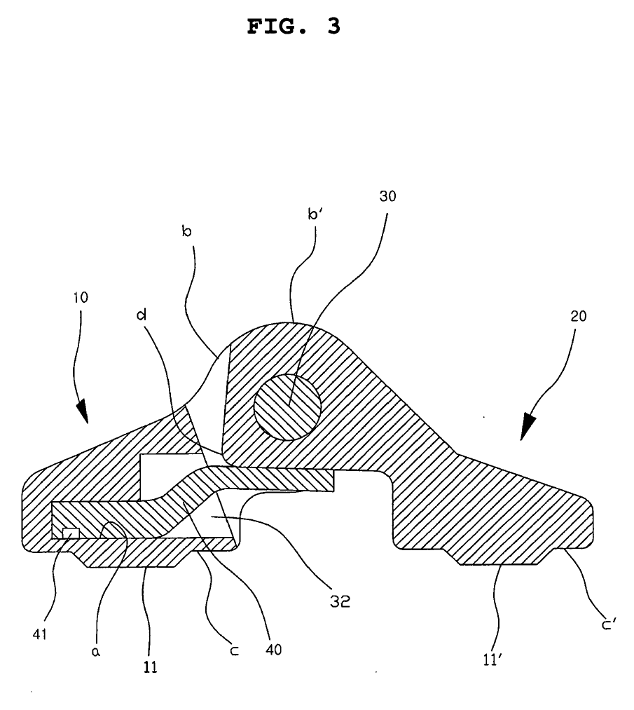

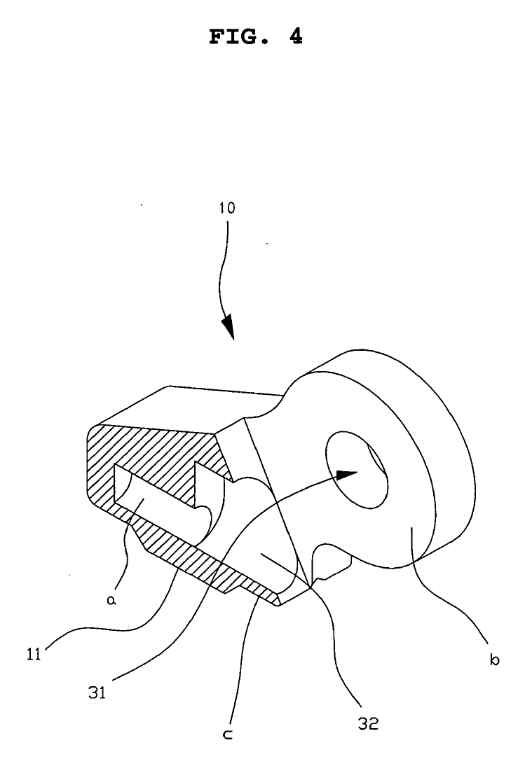

As shown in FIGS. 1 to 4, in the technical structure, the present invention is characterized in that end portions of a first member 10 and a second member 20 are respectively combined to an eyeglasses temple 1 or an end-piece 2 of an eyeglasses rim and rotatably connected thereto via a hinge pin 30, bar-type resilient means 40 is protrudingly formed on the first member 10 toward the hinge pin 30, and a cam (d) resiliently contacting to a protrusion of the bar-type resilient means 40 is formed on the second member 20.

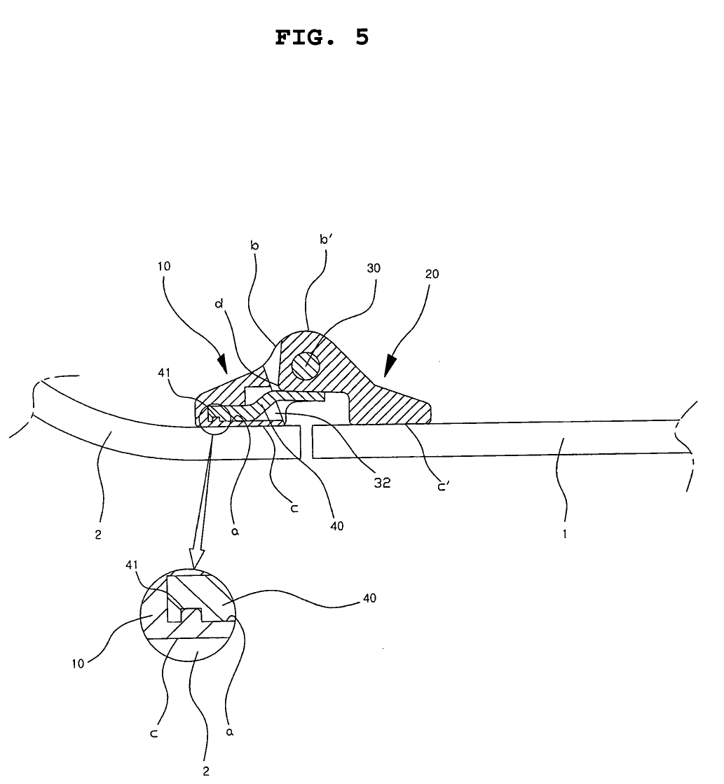

As shown in FIGS. 5 to 8, sides of the first and second members 10 and 20 are combined to the temple 1 or the end-piece 2 of the rim by welding or soldering, and so, if the temple 1 is folded or spread, the cam (d) of the second member 20 is moved to a concentric circle of the hinge pin 30. So, the contact state between the cam (d) and the bar-type resilient means 40 is transformed according to a position of the cam (d) and strength and direction of elasticity acting to the second member 20 are changed, whereby the temple 1 can keep its folded or spread state.

Here, the first member 10 includes: a pin hole 31 formed at an end portion thereof for rotatably inserting the hinge pin 30 thereto; a pair of rotating portions (b) having the outer circumferential portions formed on the concentric circle of the pin hole 31; insertion spaces of a predetermined width cut-formed between the two rotating portions (b) to rotatably combine the second member 20 thereto; an insertion hole (a) formed on an inclined surface between the insertion space by drilling, an end portion of the bar-type resilient means 40 being inserted and fixed into the insertion hole (a); and a combining portion (c) formed on the bottom surface of the other end portion thereof and having a welding portion 11 which will be combined to the temple 1 or the end-piece 2 of the rim.

It is preferable that the first member 10 has an operational space 32 formed in front of the insertion hole (a) by expanding the hole of the insertion hole (a) so that the resilient means 40 can be operated smoothly.

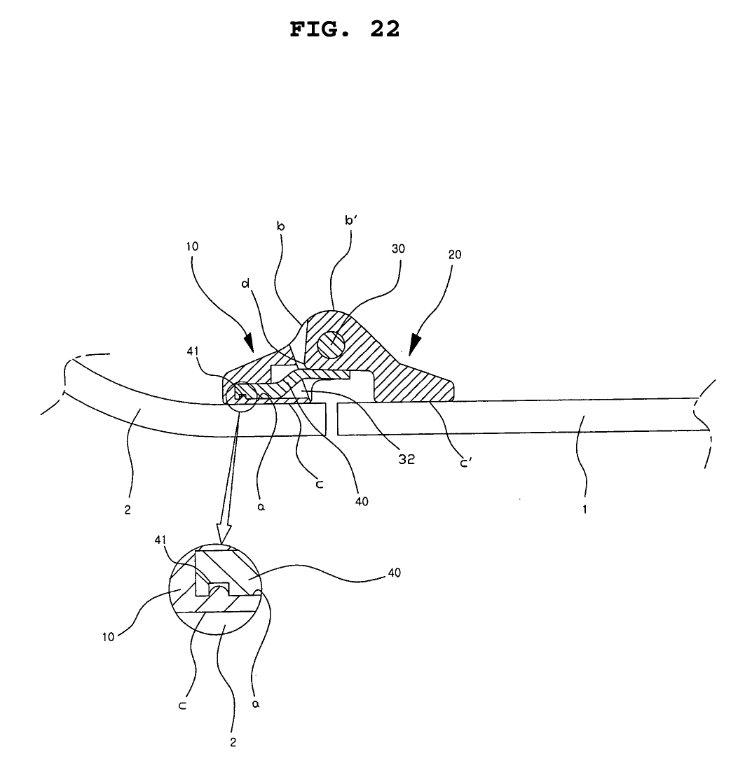

The bar-type resilient means 40 is formed by refractively expanding a plate type spring of a predetermined elasticity at a predetermined inclination angle, and has a recess 41 formed on the rear end thereof which is sealably inserted into the insertion hole (a) of the first member 10. The front end of the bar-type resilient means 40 protrudes to a predetermined length between the operational space 32 and the insertion space, and the rear end inserted into the insertion hole (a) is restricted in axial or horizontal movement since a part of the inner diameter of the insertion hole (a) is depressed toward the recess 41 when the welding portion 11 protruding from the combining portion (c) is spot-welded. Alternatively, like another embodiment shown in FIG. 22, the rear end inserted into the insertion hole (a) is restricted in axial or horizontal movement since the recess 41 is fixed by a protrusion protruding inwardly from the insertion hole (a) by punching the bottom surface of the combining portion (c) of the first member 10.

The second member 20 includes: a pin hole 31 formed on an end portion thereof so that the second member 20 is rotatably connected on the hinge pin 30 in the insertion space of the first member 10; a rotating portion (b′) formed on a concentric circle of the pin hole 31; and a cam (d) formed on a portion of the outer circumstance of the rotating portion (b′).

Moreover, the second member 20 has a combining portion (c′) formed on the bottom surface of the other end portion thereof and having a welding portion (11′) which will be combined to the temple 1 or the end-piece 2 of the rim.

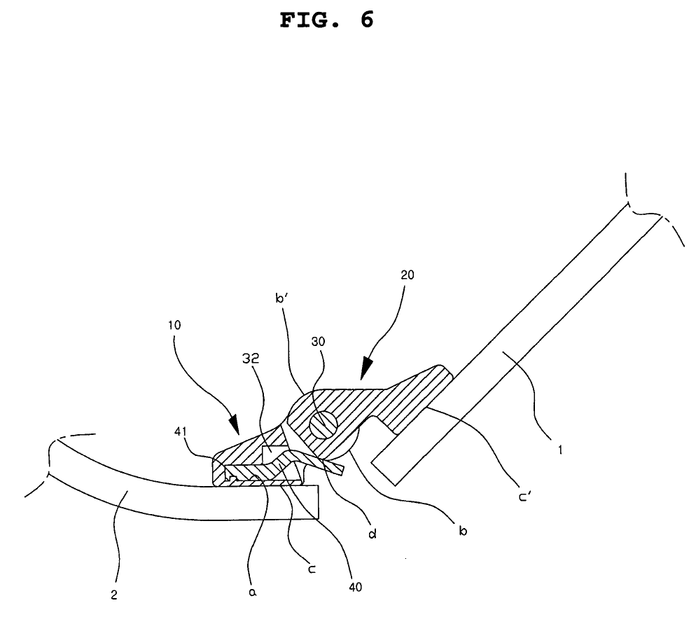

The rotating portions b and b′ of the first and second members 10 and 20 respectively perform a relative rotating motion in opposite directions on the hinge pin 30, and in this instance, the cam (d) formed on the rotating portion (b′) of the second member 20 is also moved on the hinge pin 30 along a predetermined radius (see FIG. 6), whereby the cam (d) slidably contacts with the bar-type resilient means 40 along the upper surface of the resilient means 40.

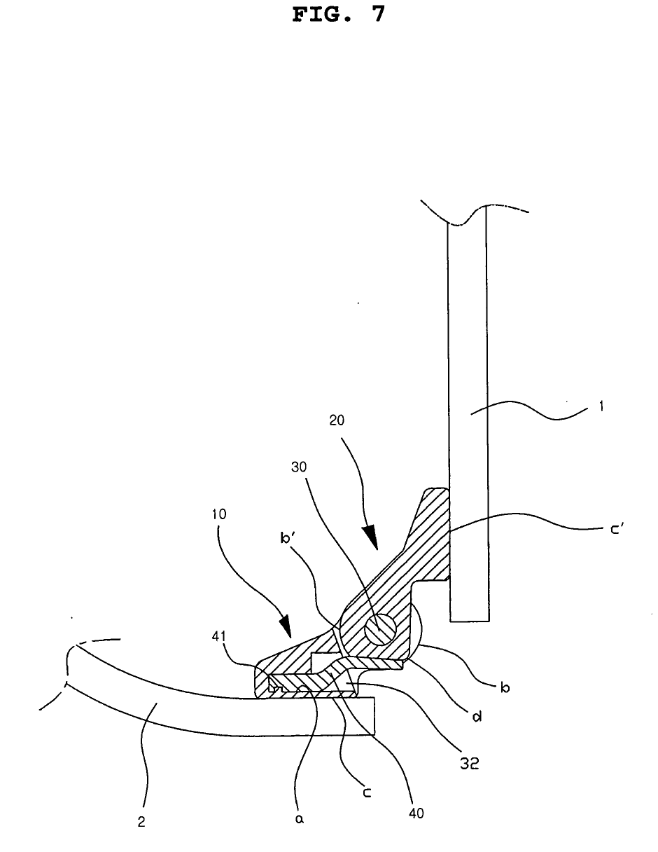

In this instance, the bar-type resilient means 40 is bent resiliently and applies resiliently pushing power to the cam (d), so that the first and second members 10 and 20 can perform the relative rotating motion in a forward or backward direction at a predetermined direction (see FIGS. 5 and 7). When the cam (d) is rotated at the predetermined direction, the front end of the resilient means 40 is in contact with a side of the rotating portion (b′) of the second member 20, and in this instance, its resistivity is greater than elasticity of the resilient means 40 so that the rotation is restricted.

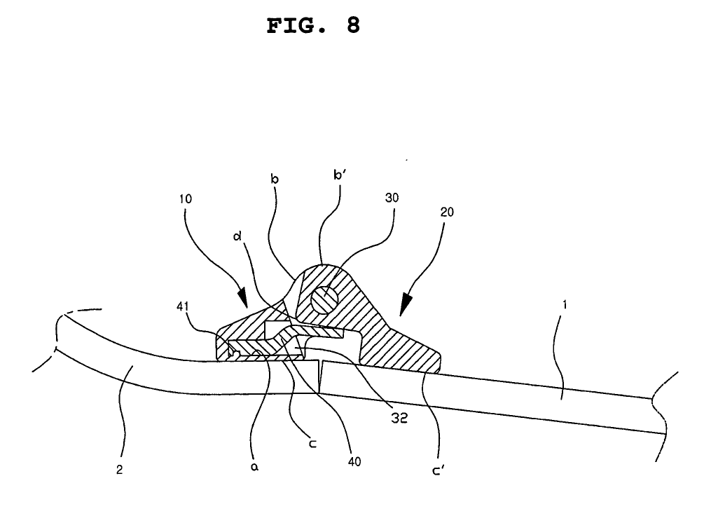

FIG. 8 shows a case that the rotating portions of the first and second members are rotated outwardly in a state where the temple 1 is spread.

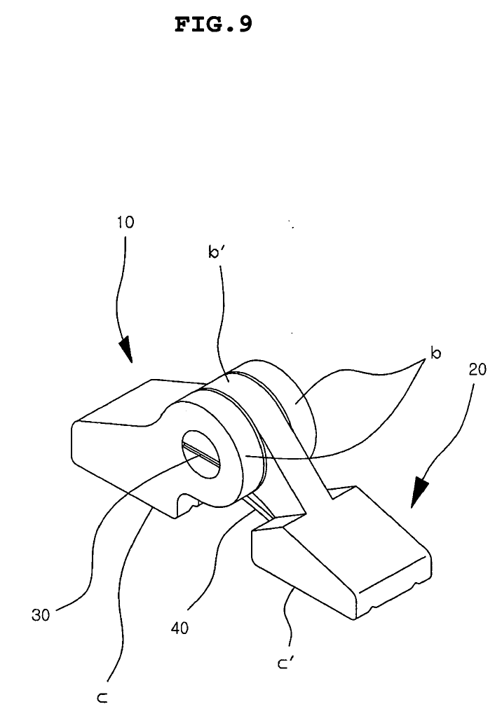

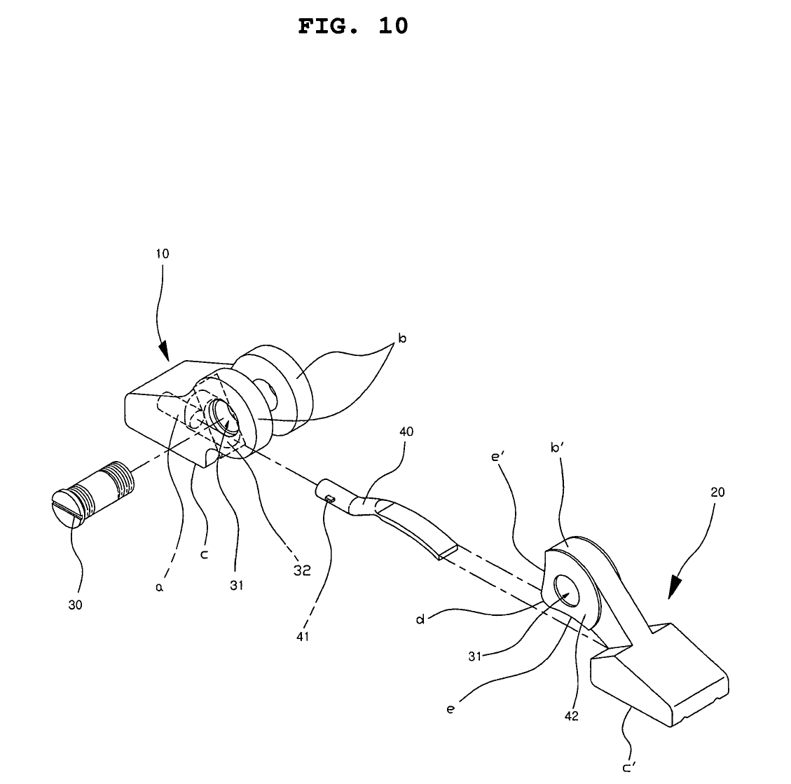

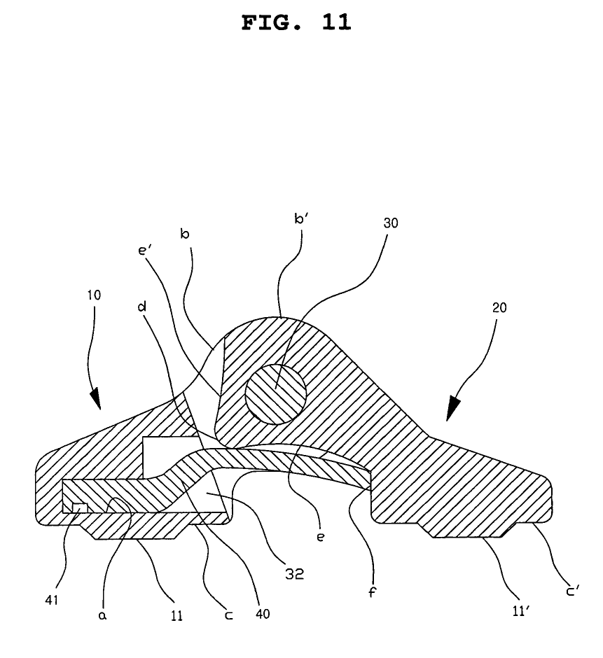

Meanwhile, FIGS. 9 to 15 show another embodiment of the present invention. In FIGS. 9 to 15, the second member 20 includes: concave surfaces (e, e′) formed on both sides inclined at a predetermined angle on the outer circumference of the rotating portion (b′) thereof; a cam (d) having the same diameter as the rotating portion (b′) and being formed at a position where the two concave surfaces (e, e′) are met with each other; and a perpendicularly refracted surface (f) formed on the other end portion extending with the concave surface (e).

In addition, the front end of plate-type bent resilient means 40 is in close contact with the refracted surface (f) where the end of the concave surface (e) extends to the other end of the second member 20.

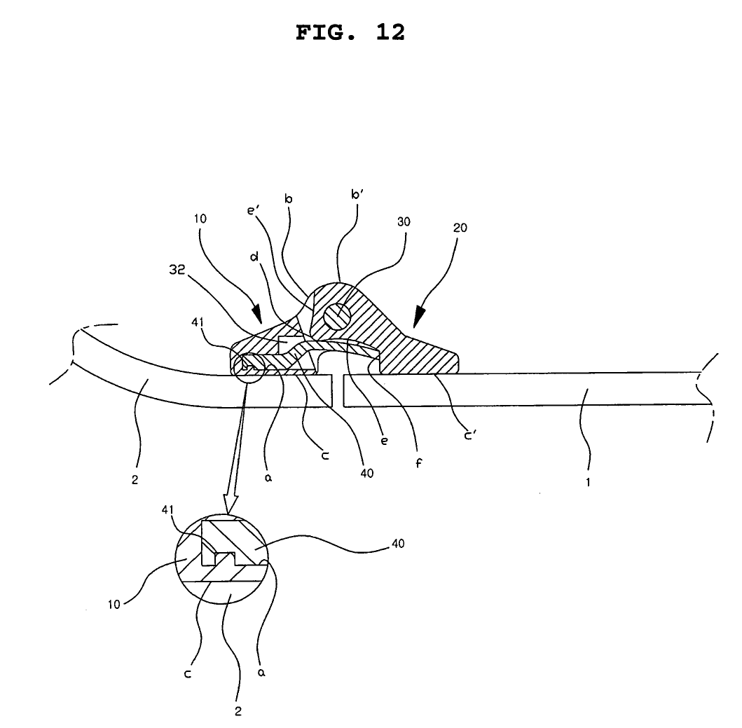

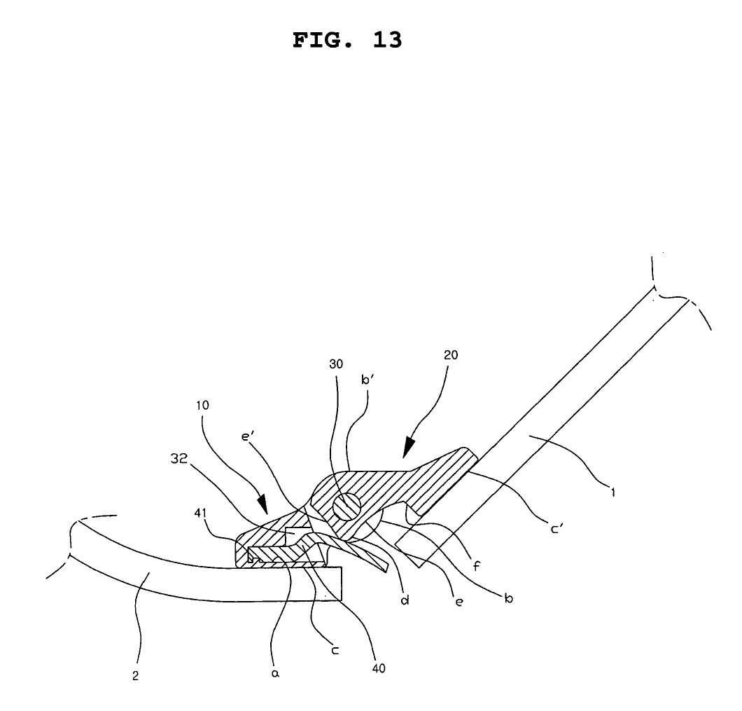

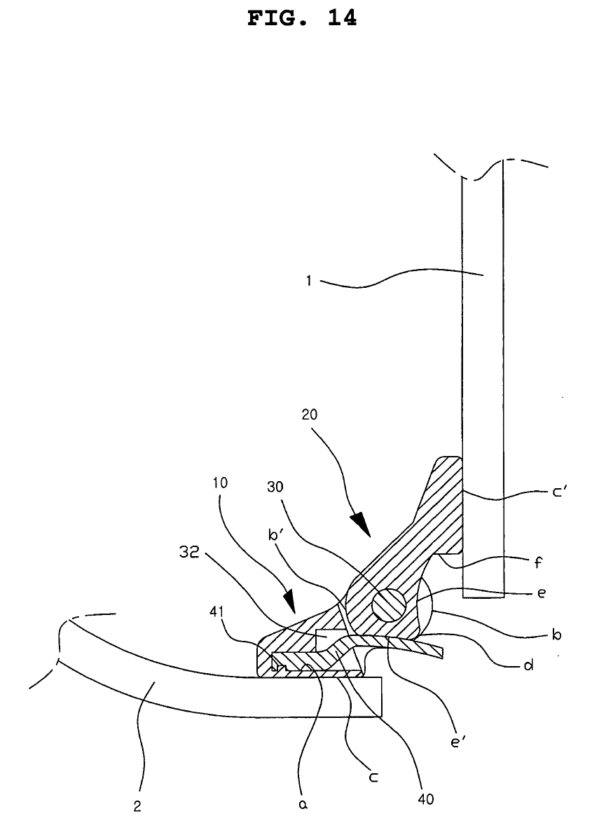

As shown in FIGS. 12 to 15, when a predetermined rotating force is applied to the first member 10 or the second member 20, the cam (d) performing the relative rotating motion is rotated at a predetermined angle in a rotational direction while pushing the resilient means 40 (see FIG. 13), and when the resilient means 40 is in contact with the cam (d) and the end of the concave surface (e), the rotation is restricted (see FIG. 12). When the predetermined rotating force is applied in the opposite direction, by the same principle, the cam (d) is rotated at the predetermined angle, and then, the end of the other concave surface (e′) and the cam (d) are resiliently supported on the resilient means 40, whereby the rotation is restricted (see FIG. 14).

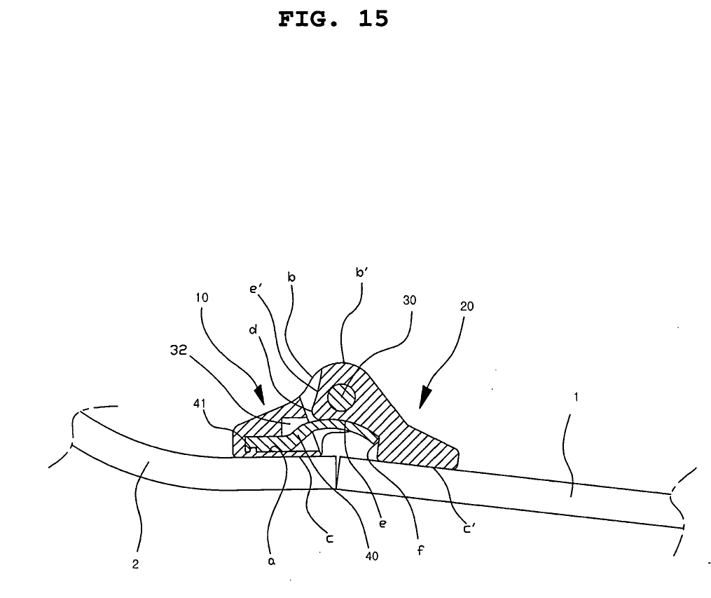

Meanwhile, in a state where the combining portions (c, c′) of the first and second members 10 and 20 are spread on the same line, when rotating force is applied outwardly (see FIG. 15), repulsive power of the resilient means 40 is increased more since the front end of the resilient means 40 is caught to the refracted surface (f) of the end of the concave surface (e) not to be spread. After that, when external force is removed, the first member 10 and the second member 20 are returned to their original states where the combining portions are on the same line.

Meanwhile, in the case where the first member 10 and the second member 20 are made of titanium, lubricating members 42 coated with ceramic material are respectively formed on the inner surfaces of both rotating portions (b) of the first member 10 and both sides of the rotating portion (b′) of the second member 20 to reduce friction resistance and a wear rate.

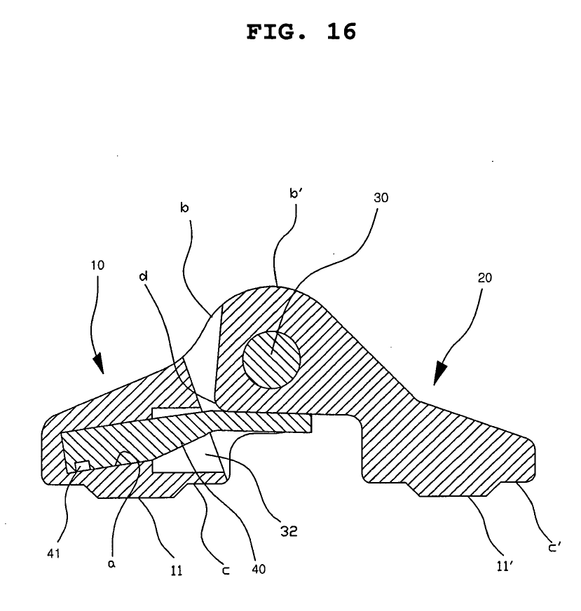

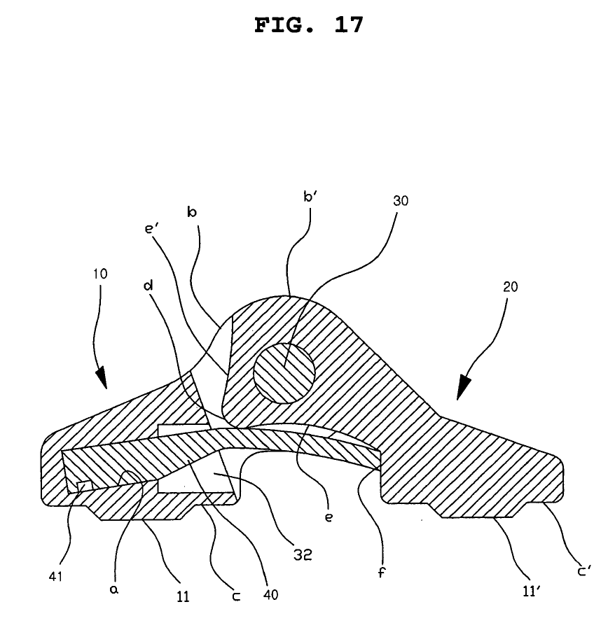

FIGS. 16 and 17 show an example that the bar-type resilient means 40 is inclinedly inserted into the insertion hole (a) formed on the first member 10. In FIGS. 16 and 17, the first member 10 includes: a pin hole 31 formed at an end portion thereof for rotatably inserting the hinge pin 30 thereto; a pair of rotating portions (b) having the outer circumferential portions formed on the concentric circle of the pin hole 31; an insertion space of a predetermined width formed between the two rotating portions (b) in a cut form to rotatably and movably combine the second member 20; an insertion hole (a) formed on an inclined surface between the insertion space by drilling and inclined at a predetermined angle, an end portion of the bar-type resilient means 40 being inserted and fixed into the insertion hole (a); and a combining portion (c) formed on the bottom surface of the other end portion thereof and having a welding portion 11 which will be combined to the temple 1 or the end-piece 2 of the rim.

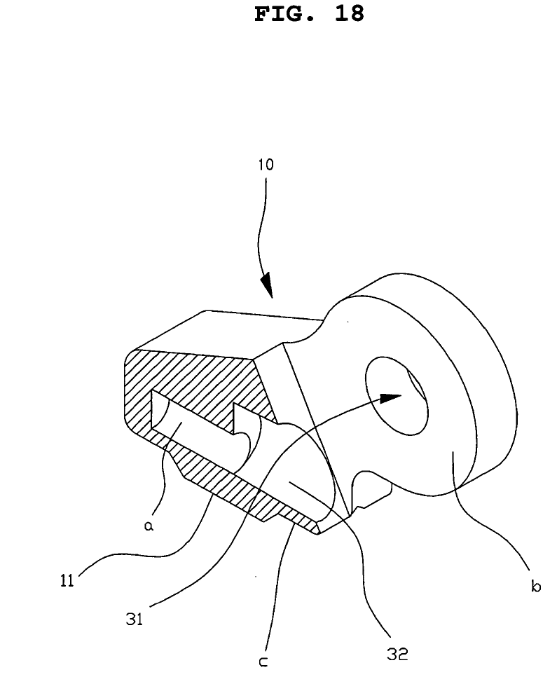

FIG. 18 shows another embodiment of the first member according to the present invention. The first member 10 has a round operational space 32 formed in front of the insertion hole (a) by expanding the hole.

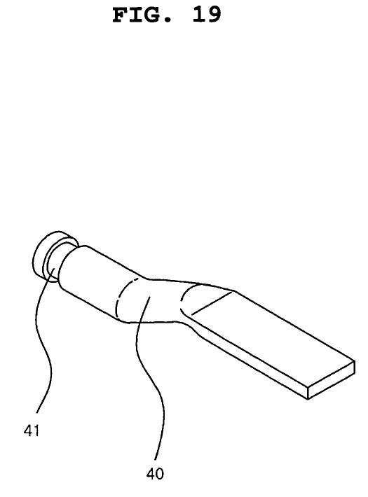

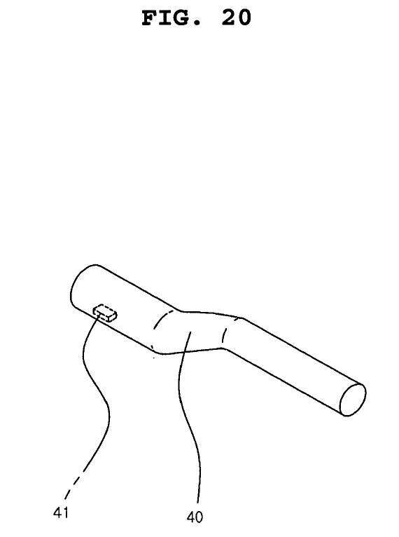

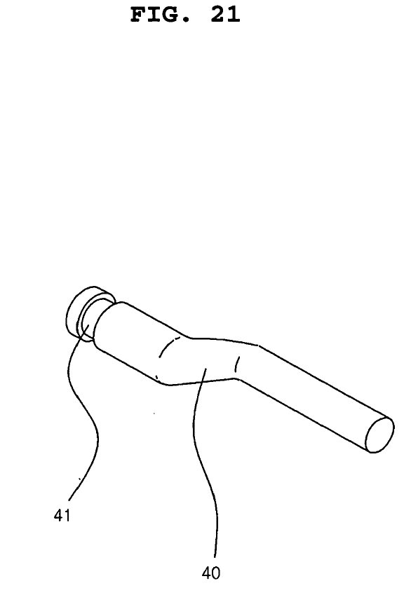

FIGS. 19 to 21 show other examples of the bar-type resilient means 40 according to the present invention. In the drawings, the bar-type resilient means 40 has a form that a plate type spring or a bar type spring having a predetermined elasticity is bent and enlarged with a predetermined inclination level, and includes a groove 41 formed on the outer circumference at the rear end thereof.

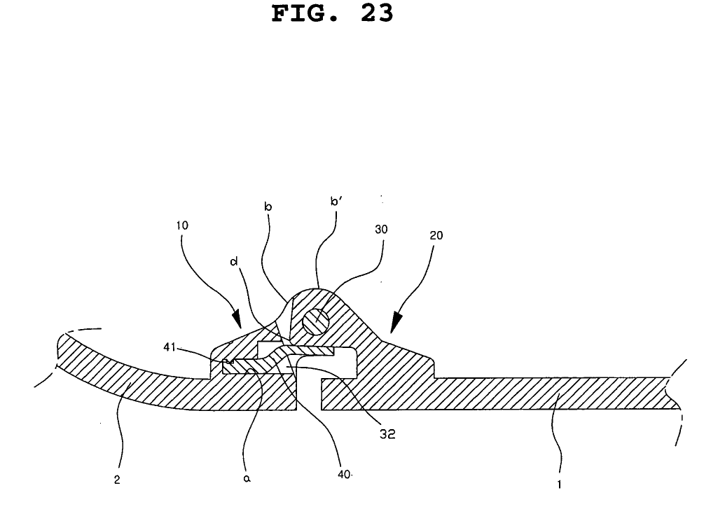

FIG. 23 is a sectional view showing another example of the first member 10 and the second member 20 according to the present invention. In FIG. 23, the first member 10 and the second member 20 are formed integrally with the temple 1 and the end-piece 2 of the rim.

As described above, since the bar-type resilient means is mounted on the first member rotatably combined to the temple or the end-piece of the rim on the hinge pin and the cam resiliently mounted on the resilient means is formed on the second member, the end-piece of the rim and the temple can be resiliently folded or spread and keep the folded or spread state, so that the spring hinge can provide a simple structure, reduce its size remarkably, improve productivity due to reduction of an assembling process, and enhance the degree of freedom in design.

1. A spring hinge for eyeglasses, which is rotatably connected to an eyeglasses temple or an eyeglasses rim via a hinge pin (30), the eyeglasses spring hinge comprising:
a first member (10) having resilient means (40) protruding toward the hinge pin (30); and
a second member (20) having a cam (d) which is in resilient contact with the resilient means (40).

2. The spring hinge for eyeglasses according to claim 1, wherein the first member (10) includes: a pin hole (31) formed on an end portion thereof for rotatably inserting the hinge pin (30) thereto; insertion spaces of a predetermined width cut-formed at the center thereof for rotatably combining the second member (20) thereto; and an insertion hole (a) formed on a side thereof between the insertion spaces, whereby an end portion of the resilient means (40) is fittingly fixedly to the insertion hole (a).

3. The spring hinge for eyeglasses according to claim 1, wherein the second member (20) includes: a pin hole (31) formed at an end portion thereof for rotatably connecting the hinge pin (30) between the insertion spaces of the first member (10); a rotating portion formed on a concentric circle of the pin hole (31); and a cam (d) formed on a portion of the outer circumferential surface of the rotating portion.

4. The spring hinge for eyeglasses according to claim 1, wherein the resilient means (40) is constructed of a plate type spring or a bar type spring having a predetermined elasticity, and has a rear end portion sealably inserted into the insertion hole (a) of the first member (10), and a front end portion protruding to a predetermined length between the insertion spaces.

5. The spring hinge for eyeglasses according to claim 1, wherein concave surfaces (e, e′) are formed on both sides inclined at a predetermined angle on the outer circumferential surface of the rotating portion of the second member (20), and the cam (d) is formed at a position where the two concave surface (e, e′) are met with each other.

6. The spring hinge for eyeglasses according to claim 1, wherein the first member (10) and the second member (20) are formed integrally to the eyeglasses temple or an end-piece (2) of the eyeglasses rim.

7. The spring hinge for eyeglasses according to claim 1, wherein the second member (20) has a refracted surface (f) formed on the other end portion thereof to which the concave surface (e) is extended, and the front end of the resilient means (40) is in close contact with the refracted surface (f).

8. The spring hinge for eyeglasses according to claim 2, wherein a lubricating member (42) is formed on the rotating portion of the first member (10) or the second member (20).

9. The spring hinge for eyeglasses according to claim 2, wherein the rear end portion of the resilient means (40) inserted into the insertion hole (a) is restricted in its movement by a protrusion protruding inwardly from the insertion hole (a) by punching the bottom surface, which is a combining portion (c) of the first member (10).

10. The spring hinge for eyeglasses according to claim 2, wherein the rear end portion of the resilient means (40) inserted into the insertion hole (a) is restricted in its movement since the inner diameter of the insertion hole (a) is depressed inwardly when the combining portion (c) of the first member (10) is welded to combine.

11. The spring hinge for eyeglasses according to claim 5, wherein the second member (20) has a refracted surface (f) formed on the other end portion thereof to which the concave surface (e) is extended, and the front end of the resilient means (40) is in close contact with the refracted surface (f).

12. The spring hinge for eyeglasses according to claim 3, wherein a lubricating member (42) is formed on the rotating portion of the first member (10) or the second member (20).

13. The spring hinge for eyeglasses according to claim 4, wherein the rear end portion of the resilient means (40) inserted into the insertion hole (a) is restricted in its movement by a protrusion protruding inwardly from the insertion hole (a) by punching the bottom surface, which is a combining portion (c) of the first member (10).

14. The spring hinge for eyeglasses according to claim 4, wherein the rear end portion of the resilient means (40) inserted into the insertion hole (a) is restricted in its movement since the inner diameter of the insertion hole (a) is depressed inwardly when the combining portion (c) of the first member (10) is welded to combine.
